(19) United States
(12) Patent Application Publication
(10) Pub. No.: US 2006/0253526 A1
(43) Pub. Date: Nov. 9, 2006

(54) Wireless networking system and method

(76) Inventors: John Thomas Welch, Provo, UT (US); Brian Andrews, Auckland (NZ)

Correspondence Address: ST. ONGE STEWARD JOHNSTON & REENS, LLC, 986 BEDFORD STREET, STAMFORD, CT, 06905-5619, US

(21) Appl. No.: 11/371,802

(22) Filed: Mar. 9, 2006

Related U.S. Application Data
(63) Continuation of application No. PCT/NZ04/00209, filed on Sep. 7, 2004.

(30) Foreign Application Priority Data
Sep. 9, 2003 (NZ) 528127

(51) Int. Cl. G06F 15/16

(52) U.S. Cl. 709/200

(57) ABSTRACT

A wireless networking system comprising: a series of points of presence (POP) each having at least one intelligent network node (INN) housing a computer processing unit interconnected to a series of or including a series of radio transmission devices. Each INN provides multiple radio communication paths to other INNs and portable wireless communication devices (roaming end user devices). The INNs can also provide wireless network backhaul operations for transmission of information from the roaming end user devices to other INNs or at least one primary aggregation point (PAP) for on transmission to other communications networks.

### CROSS-REFERENCE TO RELATED APPLICATIONS

This application is a continuation of International patent application No. PCT/NZ2004/000209 filed on Sep. 7, 2004, which designates the United States and claims priority of New Zealand patent application No. 528127 filed on Sep. 9, 2003.

### FIELD OF THE INVENTION

The present invention relates to the field of wireless networks and, in particular, discloses a network of computational nodes suitable for facilitation of an overall efficient multipoint-to-multipoint infrastructure-based wireless network system, supporting IEEE 802 standard metropolitan-wide commercial networks. The network provides efficient support for near ubiquitous radio coverage. In addition, the logical network can be extended, and the investment in the centralized infrastructure leveraged, by adding geographically dispersed nodes connected across the Internet via virtual private network (VPN) technologies.

### BACKGROUND OF THE INVENTION

Recently, wireless based computer systems are becoming increasingly popular. In such arrangements, portable mobile computers, cell phones etc. are able to “roam” around a geographical area whilst being in communication with a series of radio base stations. The intercommunication with the radio base station allows for communication and the traffic of information to or from the roaming device.

In particular, wireless computer networks based on, for example, the IEEE 802.11 standard is becoming increasingly popular. In any wireless network system, it is important to effectively and efficiently transmit information around the network. Further, it is important to have effective controls over access to the network and provide for redundant operations in the case of network element failures.

Existing 802.11 wireless networks are not fully conducive to a commercial environment as essential functions such as roaming, data-routing, accounting, redundancy and authentication are not handled efficiently. Similarly, comparative solutions are not cost-effective due to the large number of radio devices required to achieve near ubiquitous coverage over large network areas.

### SUMMARY OF THE INVENTION

It is an object of the present invention to provide for the efficient operation of metropolitan-wide IEEE 802.11 wireless networks, providing near ubiquitous coverage to a defined geographical area for a specified maximum number of simultaneously connected constituent devices. In addition, the logical network can be extended by adding geographically dispersed nodes connected across the Internet via virtual private network (VPN) technologies. In accordance with a first preferred feature of the present invention, there is provided a wireless networking system comprising: a series of points of presence (POP) each having at least one intelligent network node (INN) housing a computer processing unit interconnected to a series of or including a series of radio transmission devices. Each INN provides multiple radio communication paths to other INNs and portable wireless communication devices (roaming end user devices). The INNs can also provide wireless network backhaul operations for transmission of information from the roaming end user devices to other INNs or at least one primary aggregation point (PAP) for on transmission to other communications networks.

At each PAP or secondary aggregation point (SAP) intelligent network servers (INS) provide centralized network services for the system in addition to supporting distributed network services managed by the INN. Centralized PAP & SAP services can include centralized network management, network monitoring, DNS, DHCP, web services, database services, VPN termination and authentication. The INS services can extend the wireless network geographically by allowing VPN connections from remote INN over the Internet. These INN may use various Internet capable connections such as DSL, Ethernet or fibre optic cable.

The distributed network services at each INN provide support for efficient network operation including management of backhaul links, end user device roaming; distributed authentication, distributed pre-authentication, distributed web services, distributed RADIUS, distributed database services, distributed routing, firewalling and network monitoring services.

Communication between INS and network INNs can occur via wireless transmissions. They can also occur from any other Internet connected location via secure VPN connections. The potential wireless paths between the network nodes are of a predetermined nature and the INNs at each POP route traffic through the network via inter-INN communication exchanges and based on INN-to-INN and radio-to-radio relationships, primarily carried via the systems own software-based IAPP (Inter-Access-Point Protocol) daemon. Dynamic network conditions can also be factored into the routing rules and result in efficient path selection. Such conditions may include link-state, link distance, path cost, priority, link-load, level of packet-loss on the link, radio signal strength and quality and the number of connected devices on a path. The routing rules and dynamic changes are used in combination to enforce a low maximum hop count between any two points on the network. This also results in reduced packet loss, path diversity (multiple paths to alternative backhaul links), increased redundancy and greater throughput due to lower latency. Such an arrangement is highly suitable for latency sensitive end-user applications such as VoIP. Initial path configurations are loaded and initialized at INN boot time. Each INN securely interrogates an INS database server holding the centralized network configuration in order to populate its own configuration database. Once booted, the INN continuously enforces its relationship rules for inter-INN communication and routing decisions. Each INN and radio may have different configurations and rules depending on its role in the network.

The wireless networking system supports end user traffic destined for external networks or intra-network devices, being peer-to-peer or metropolitan-wide virtual private network (VPN) communications. The wireless networking system interfaces with telecommunication carrier or service provider networks (Operator's networks) to provide metropolitan-wide roaming 802.11 network services for the Operator's end users. Interconnect points at the PAP or SAPs, allow transmission of end user statistics and network monitoring information to external networks. These connections to the Operator's network or other telecommunications networks including the public switched telephone network (PSTN) and cellular networks, may be via fibre (terrestrial) or some other high capacity wireless media.

The wireless networking system can support IEEE 802.11 compatible wireless end user devices, and is preferably vendor agnostic. The present invention is not limited to 802.11 networks and applies equally to other network standards (including 802.16 and 802.20) for the provision of a distributed wireless network arrangement.

### BRIEF DESCRIPTION OF THE DRAWINGS

Preferred forms of the present invention will now be described with reference to the accompanying drawings in which:

FIG. 1 illustrates schematically a wireless network of the preferred embodiment;

FIG. 2 illustrates the process of distributing software to INN devices;

FIG. 3 illustrates the process of downloading software at bootup time;

FIG. 4. illustrates the INN structure of the preferred embodiment;

FIG. 5 illustrates in more detail the INN structure of the preferred embodiment;

FIG. 6 illustrates the form of information flow between a user and the Internet in accordance with the system of the preferred embodiment;

FIG. 7 illustrates the interrelationship between networks as utilised in the preferred embodiment;

FIG. 8 illustrates the processing of IP packets by network software;

FIG. 9 illustrates one form of traffic flow across the network;

FIG. 10 illustrates one form of intra network traffic flow across the network; and

FIG. 11 illustrates schematically the step of combining networks into an overall larger network.

### DESCRIPTION OF PREFERRED AND OTHER EMBODIMENTS

In the preferred embodiment, there is disclosed a wireless networking system, consisting of wireless networking elements hereinafter called intelligent network servers (INS) and intelligent network nodes (INN), which facilitate rapid and effective wireless network operations across metropolitan-wide areas.

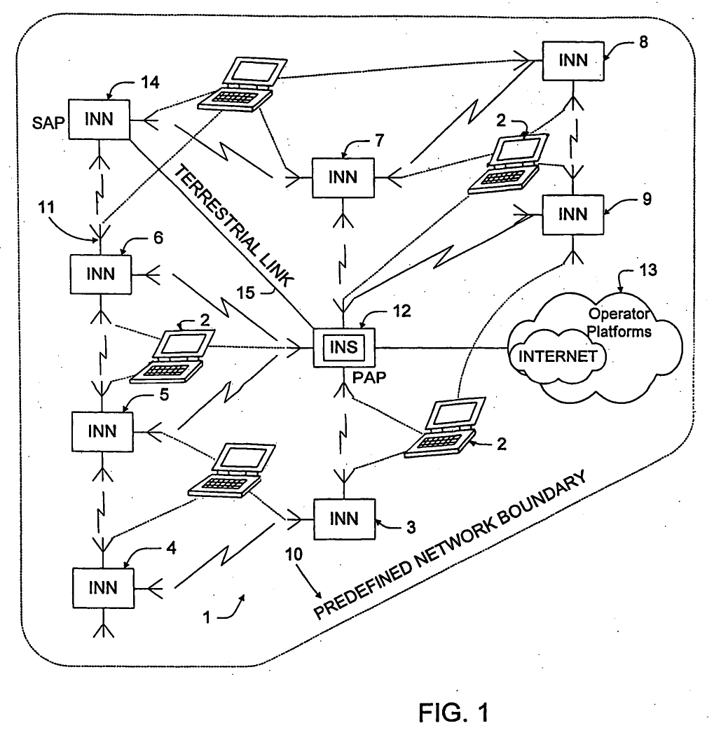

Turning initially to FIG. 1, there is illustrated schematically 1 the operational environment of the preferred embodiment. In this environment, a series of mobile communication devices e.g. 2, which can include computers or the like, are interconnected by a wireless networking system of INNs e.g. 3-9, within a predefined network boundary e.g. 10. Each INN can include a series of IEEE 802.11 compliant radio transceivers e.g. 11 with the radio transceivers acting to interconnect between INN nodes (POPs) in addition to communicating with mobile communication devices e.g. 2. A primary aggregation point (PAP) e.g. 12 is further used to house intelligent network servers (INS), providing centralised services to the other INNs and end users, and is also interconnected to other network devices 13 in the form of Operator networks and/or the Internet e.g. 13, via high capacity network links. In some embodiments, aggregation points e.g. 14 consolidate local traffic from other INNs and transport this traffic to INS servers via high capacity wireless or terrestrial links 15. The arrangement 1 thereby provides Internet type access and metropolitan-wide cross-traffic for VPN or peer-to-peer applications to the mobile communications device 2. The device 2 may provide various user-specific facilities including applications such as voice over IP, Internet web browsing, VPN or data encryption capabilities. The capabilities can be provided by means of well-known computer networking protocols (TCP/IP, 802.11) known to those skilled in the art.

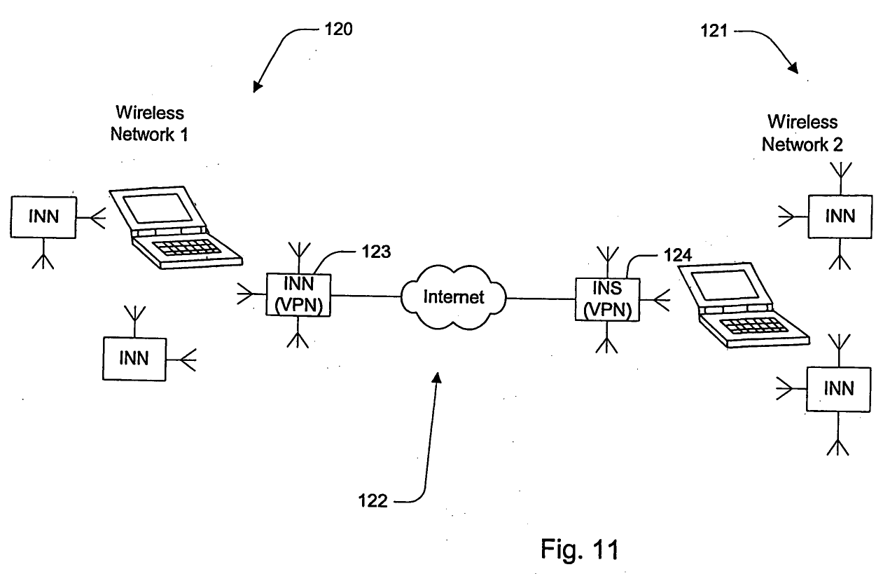

Turning now to FIG. 11, multiple wireless networks can be combined together to form an overall larger network through the utilization of INS VPN services used to allow the network to be extended over large geographic distances by allowing remote INN connections over the Internet. In this example, a first wireless network 120 and a second wireless network 121 are interconnected via a Virtual Private Network (VPN) which is formed by connecting INN device 123 with INS device 124 by means of a direct VPN processes running on each device 123, 124 with the devices being connected over the Internet. It will be understood that the VPN connection is virtual and can be run on corresponding INN/INS hardware devices.

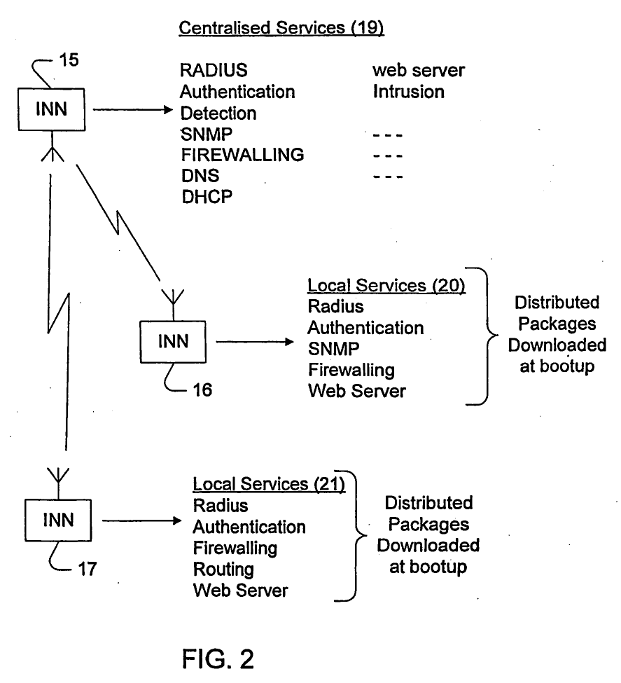

FIG. 2 shows the relationship between the INS e.g 15 and the INNs e.g. 16 and 17, in terms of configuration management. All INN software is combined into relatively small and related software code “packages”. Each device 15-17 is able to download packages at boot-up eg 19-21 and centralised network services e.g 19 provided over local area networks (LAN) vs distributed network services e.g. 20, 21 provided over the wireless networking system. The INS 15 provide automated configuration management via the code packages that are downloaded by each INN 16,17 when the INN boots up. As each INN may perform differing tasks than other INNs, based on its logical position or role in the network, code packages,relationship, firewall and routing rules are downloaded by INNs to enable it to perform its predefined system functions. The INS servers keep an up-to-date database of the entire network setup including device configurations, and therefore the corresponding code packages required.

The system allows for changing wireless standards to be accommodated as they are developed and support for new devices as they are introduced. Therefore software needs to be easily upgradeable across the network. This is also addressed by utilizing a comprehensive code management architecture in the networking system. Code packages are remotely upgradeable across the system and are also downloaded in an encrypted format each time an INN is booted-up. INS servers are created using the same software packages as the INNs, therefore future wireless standards can be supported across the entire network with relative ease.

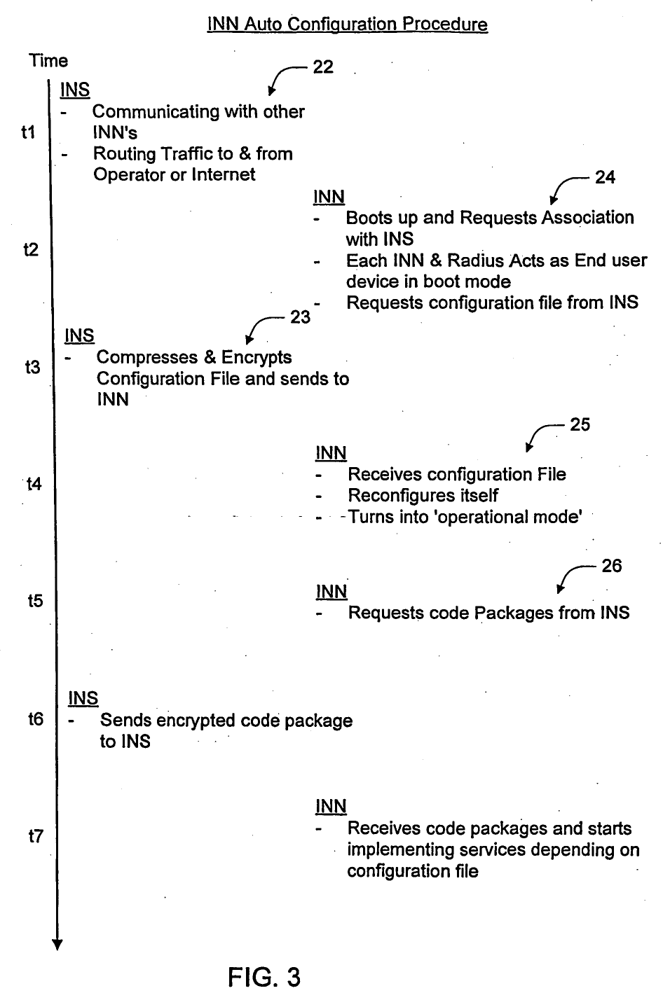

Turning to FIG. 3, there is illustrated the auto-configuration procedure in more detail. Differences between INNs, and between INS, are specified in the INN or INS configuration file, retrieved at bootup by each INN from a master INS database. This happens before the INN downloads any code packages. At this time, the INN boots-up with its radios acting as end-user devices (“boot mode”) 24 using standard boot-time configuration settings that are the same for all INNs. The INN's radios subsequently associate and authenticate as end-users to other network radios that have already completed the boot-up process (“operational mode”). The link from each of these radios to the master INS database are tested for validity before the INN uses the first usable, or best quality link to attempt to retrieve its own encrypted configuration file 25. A usable link may include a VPN connection from a remote INN via a DSL or similar connection. Once successfully retrieved, the INN unencrypts the configuration file and verifies that it is valid before reconfiguring itself into operational mode using the customized values from the file. These values can differ from INN to INN and from INS to INS. For example, if an INN or INS is to act as a DNS server it has the DNS configuration values in its configuration file. It will also download the DNS code package when it enters operational mode 26.

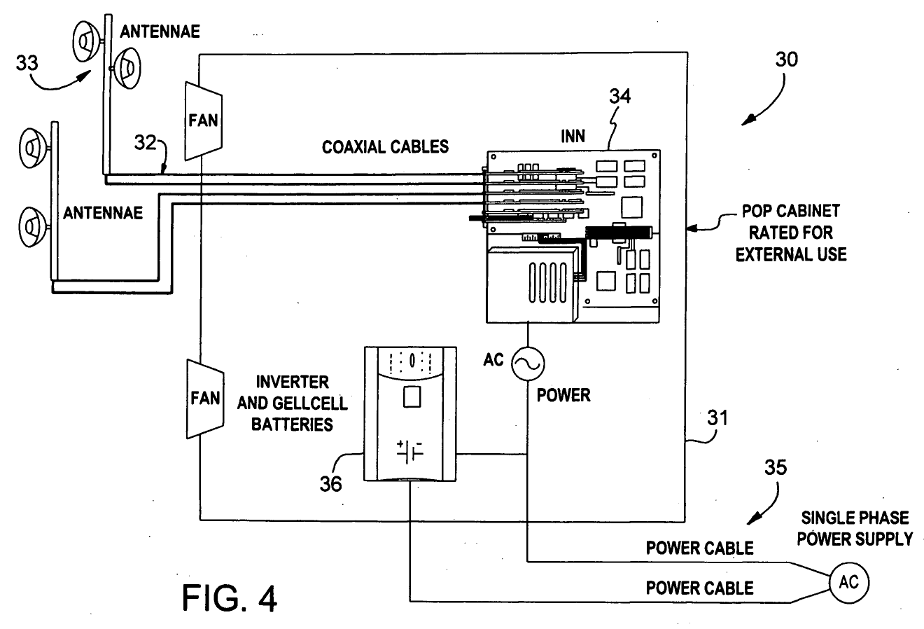

Turning now to FIG. 4 there is illustrated a current typical INN structure in more detail 30. The INN structure can be enclosed in a cabinet suitable for external environments and includes a series of coaxial cable connections 32 to a series of antennae eg 33. The INN device can be interconnected to the power supply 35 in addition to having a backup power supply 36. Power may also be supplied via Power over Ethernet (POE) cabling. Environmental control mechanisms are optional to control the operating environment within the cabinet.

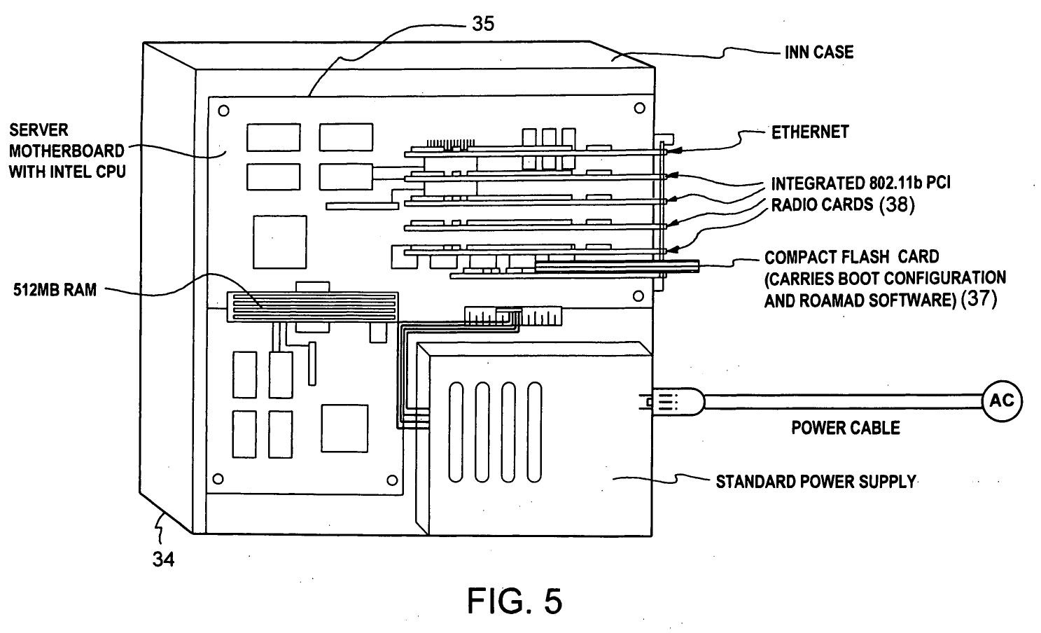

Turning now to FIG. 5, there is illustrated schematically the core structure of a current INN type device 35. The computer hardware components are based around the use of an x86 compatible processor executing the Linux operating system. Boot configuration information can be carried by compact flash 37. IEEE 802.11 radio cards 38 are interconnected to the INN by an internal direct connection such as the computer's PCI bus or by external connection via an Ethernet, USB or similar connection. The radio cards are connected to external antenna devices using coaxial cable and connectors. There is no requirement for terrestrial data cabling from each POP site to PAP (or SAP) sites as the INN can provide wireless backhaul functionality between these sites via the radios.

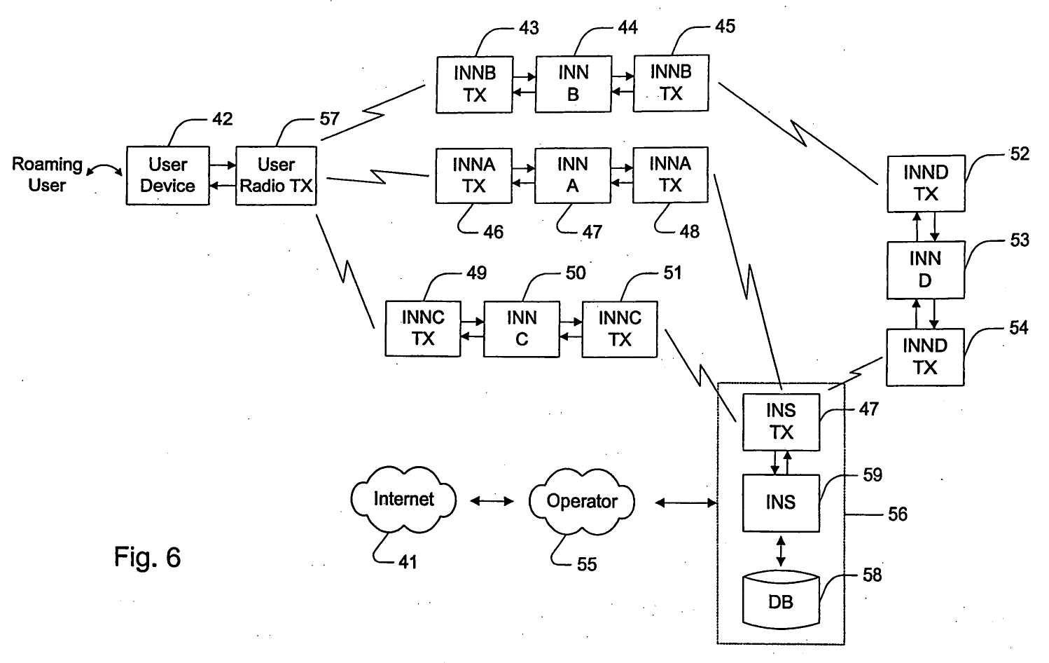

The layout of the INN network is ideally setup such that each user radio device is able to communicate with at least three INN type devices. FIG. 6 illustrates schematically one form of intercommunication between a user device e.g. 42 and an external network e.g. 41. The user device 42 includes an 802.11 radio transmitter 57 which can communicate with at least three radio transceivers 43, 46 and 49, with each transceiver being interconnected to its INN 44, 47 and 50. The INN devices forward packets to and from an INS 59, with, in the given example, the packets from INN going by intermediary INN device 53. The INS is directly connected to a terrestrial line and from there via an operator 55 to the Internet or similar external network 41. The setup may also involve the interconnection of remote INN to the INS via a secure VPN connection. This connection may be made over the Internet via DSL, Ethernet or similar. This allows the network operator to extend the network via the use of commonly deployed hotspots or to buildup smaller geographically disparate wireless areas (hotzones) such as at campus, enterprise or alternative commercial locations. INNs connected via VPN can support all services available to network INNs.

Multiple radio transceivers can reside in a POP site. INNs may have a number of integrated 802.11 radios installed (as depicted in FIG. 4), or the radios may be external to the INN. The radios form the 802.11 paths of the network. The INN must direct traffic intelligently to allow traffic to flow across the more efficient network paths.

The INNs route the traffic across the network based on a combination of standard L2/L3 routing protocols and/or other route management system, with the INNs communicating with each other in predetermined network areas. Each INN has a predefined role in the network based on its logical location within the network topology. The routing patterns can be designed to provide near optimal performance in terms of latency, throughput and path cost. Efficient communication and traffic processing between INN devices results in reduced packet loss, diversity (multi-paths to alternative backhaul links), increased redundancy and greater throughput due to lower latency.

The INNs allow for cross-network as well as inter-network traffic. This means the system can provide network services for traffic that either stays within the network or transits the network to an external network, such as another carrier's network or the Internet. Each INN forwards traffic, possibly over multiple paths, to and from a destination and source IP addresses.

Actual INN traffic routing and forwarding is performed by common Linux processes but the determination of routes can be made by different software processes and protocols. In one embodiment, this can be accomplished using common Layer 2 bridging or Layer 3 routing protocols (for example, OSPF, RIP). In addition, Ad-hoc routing protocols may be used such as OLSR or AODV. The most ideal arrangement is to have a routing protocol customised to the specific network layout of the wireless networking system. A route management system customised to the particular network arrangement is more suitable in this environment as it can take into account the mixture of infrastructure and Ad-hoc elements inherent in the network. The network's database of INN relationships (network map) can be the initial source for possible infrastructure routes. INNs upon bootup, interrogate their own local copy of the network map when determining which routes to setup and hence which wireless links to enable and maintain. A daemon software process can then be provided on each INN to constantly monitor the links and determine if a link is no longer viable and therefore, whether a route needs to be modified. The current link state can be determined by evaluating a number of variables, many specific to a wireless network, such as link quality, link data rate, number of missed beacons, link distance and link latency. The variables can be combined into a link state factor and compared with the links base level link state factor stored in the network database and propagated via the network map. If over a predetermined number of evaluations the link state factor persists below the base level, an alternative link can be sought for the network routes attributed to the poorly performing link.

In use, the network may be heavily utilised for general Internet traffic and hence the links most in use are the backhaul links to the PAP for traffic that is ultimately destined to the Internet. Alternative wireless links can be setup at boot time. As these links are already setup and functional, the INN first decides which alternative link to change a route to, before it changes its local routing information. It then tests the new link and sends a routing update message to its routing controller.

The software-based routing controller may be located at the INS gateway, or in a large network, another INN acting as an area controller. Routing updates are then made at the area controller and/or INS gateway so that traffic destined back to the INN can use the new link and so the update can take affect rapidly (rapid convergence). This route switching can occur very quickly and does not involve extensive routing update messages that can be overwhelming on other Ad-hoc type networks. Ad-hoc networks normally use infrastructure-less routing protocols that consume a lot of network resources trying to determine a structure where none may originally exists. Also, if the infrastructure elements of the network are designed well, and subsequently links perform well in terms of wireless capability, the route changes can be infrequent. This reduces the overhead of routing topology updates thereby allowing more bandwidth for end user devices.

As opposed to the above infrastructure routing process, end user traffic is routed across the network infrastructure using a combination of L2/L3 protocols. As described above, the infrastructure routing topology is constantly enforced using INN software daemons so end user traffic is highly likely to reach its destination if this infrastructure is well performing. In addition, as the location of end user device associations (ie which INN a user device is currently wirelessly connected to) is always known, via constant IAPP daemon roaming messages, routes to-and-from end-users are also rapidly enforced. When a user roams, an IAPP message is sent from the new INN to its IAPP controller notifying of a roaming event. In addition, the INN may change a route for the user if the user was not previously associated with this INN. The IAPP roaming event triggers a roaming event message to be propagated from the IAPP controller to other INNs logically associated with the new, and previous INN, to enable these INNs to modify routes for the user. Routes for users are technical versions of the question “which INN is the user located at?”. As the infrastructure is generally stable, in terms of where INNs are located in the routing topology, user routing updates are rapid and do not require extensive routing topology enquiries and updates.

When user traffic enters an INN via one of its network interfaces, such as wireless radio or Ethernet connection, a kernel-based routing and firewalling process decides whether the traffic is destined for a user connected to this INN or if the traffic is meant to be forwarded. Alternatively, if the traffic fails a local firewall rule, it can be discarded. If the traffic is intended for a locally connected user, the traffic can be bridged at Layer 2 to the appropriate network interface. If the traffic is to be forwarded, it is allowed to pass up the network routing stack so that it can be routed at Layer 3 via the infrastructure. The Layer 2 switching is advantageous in this wireless system as it simplifies the number of end-user Layer 3 routes that must be maintained on each INN thus increasing scalability. It also allows radios, which often cannot communicate entirely at Layer 3 themselves, due to the radios not understanding Ethernet ARP requests, to receive Layer 3 routed traffic. An alternative is to enable a Proxy ARP process on each interface but this is not as efficient as it generates a number of Layer 3 user routes that must be maintained.

It can also be seen from the above, the system relies on the IAPP event daemon for a number of critical functions. The system's IAPP software daemon operates on each INN but the central IAPP controller process can operate on an INS server or another predefined INN for a specific area of the network. The IAPP process can be designed around the draft 802.11f IAPP protocol. In the preferred embodiment the network processing is performed on the INN cpu rather than inefficiently on each radio's cpu as defined by 802.11f. In some embodiments of the INN, four or even six radios can be controlled by a single INN cpu therefore significantly less processing is required, as a single IAPP message is sufficient, rather than requiring one message per radio.

Technically, the IAPP event daemon is a server that sends and receives UDP packets on ports 2312 and 2313. It requires message acknowledgement for each message sent, which improves reliability. Unacknowledged messages are queued and retried a number of times, whether they originate from an INN or a controller. If the recipient INN or INS fails to acknowledge a message an SNMP alarm is triggered and the message is retried.

The IAPP daemon enables the exchange of, but not limited to, the following critical messages types: user-roamed, user-authenticated, preauthenticate-user, user-log-out. For each message type differing processes can be triggered to update internal databases. The processes also differ whether the message is received by an INN or by a controller. On a controller, messages most often originate from INNs. The following are example processes for each message type:
User roamed: A message is originally initiated by an INN when it detects a user device has associated to one of its radios when it wasn't previously associated with any of them. The receiving controller then—updates the gateway routes for the end user to the INN the user is now associated with). Notifies the other INNs (within related network areas of the initiating INN) that the user has roamed. It does this by relaying the IAPP user-roamed message. Update the network log database of the roam event. The receiving INNs update their network routes for the user. They then send back an acknowledgment.
User authenticated: This message is initiated by a successful authentication message that may originate from another INS process such as a Radius “Access-Accept” reply. The following steps are performed by the controller—update gateway routes if required, record user in system “online” database table, record event in database, propagate event to INN in related network areas via IAPP preauthenticate-user messages. Send back an acknowledgment.
Preauthenticate-user: This message is initiated by a controller IAPP process and received by INNs. Each INN performs the following steps upon message receipt: record user details in local database, setup user routes if required, update firewall rules, setup QoS rules if required. Send back an acknowledgment.
User-log-out: Message is initiated by an INS network management server responsible for network SNMP polling. If a user device fails to be acknowledged as being active on any INN (collected via regular SNMP polling requests to each INN) an IAPP message is generated by a controller and sent to the INNs. Similarly, if an end user initiates a manual logout process (eg via a web site logout button) a user-logout process is initiated. The receiving INN will perform the following actions: remove user from local database, routing, firewall and QoS tables. Send back an acknowledgment.

The system can also support the addition of wireless infrastructure nodes in an ad-hoc style to extend and enhance the network (ad-hoc INN). Once the core wireless backhaul nodes and links are in place, additional INNs may be installed to provide additional wireless coverage for end user devices. Within the network database, these INN can be configured to allow association to any other INN to form temporary or unplanned links. On bootup these ad-hoc INN cycle through locally available wireless signals to determine the best signal to form a network link with and thus provide wireless backhaul. Factors, such as those mentioned previously to determine the link state factor, are computed to provide a ranked list of radios to test a possible link to. The ad-hoc INN first associates to the infrastucture radio as an end user device and negotiates the creation of a link. The interrogated INN first checks with an INS server whether the credentials of this ad-hoc INN are valid, and if ok, sets up its internal systems to allow the INN to form a link with itself. It then notifies the ad-hoc style INN when it is ready to do this. The ad-hoc INN then disassociates and reconfigures itself to form the network link as previously negotiated. The ad-hoc INN then continues its standard boot-up process, retrieving the appropriate software packages it requires etc. If the ad-hoc INN physically contains other radios, these can be configured to be automatically setup in order to provide end user coverage. This is done by firstly performing a localised software-based site survey to determine the best radio channel to use to not conflict with other localised signals and its own network link that was previously created. The ad-hoc INN also enables its Ethernet ports for user access, which is especially useful if the device is located in a small business such as a cafe or an office. Ad-hoc INNs can be are configured to accept associations from user devices on their user centric radios and generally not on the backhaul link. The ad-hoc INN may be interfaced with the network easily without much of the planning and installation required for an infrastructure INN.

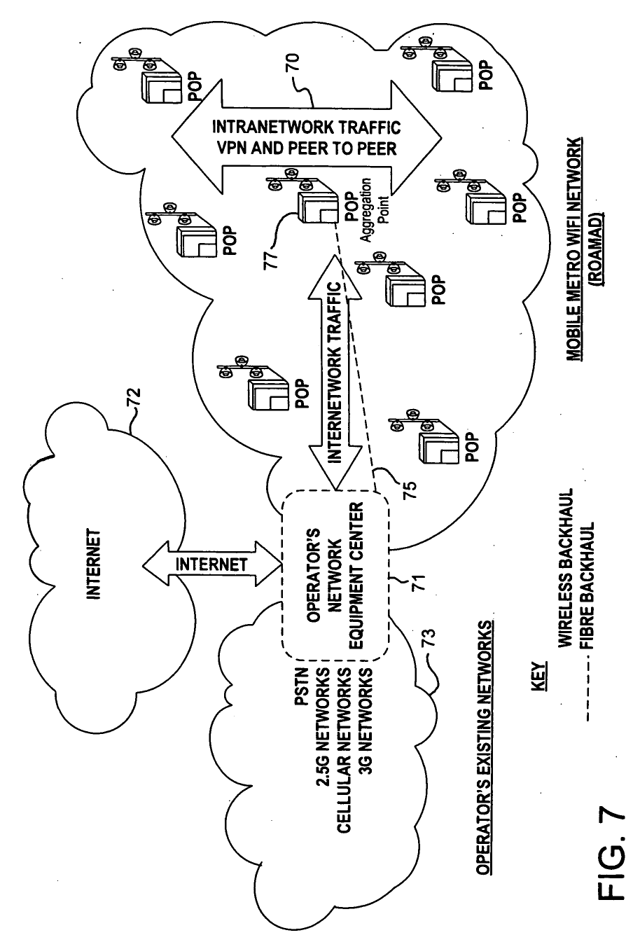

The system itself can also interface with telecommunications carrier networks to provide a metropolitan-wide roaming 802.11 network service. The system allows for fibre connections (terrestrial) if desired, between aggregation point INNs and the INS located at the Operator's network equipment center. Such an arrangement is illustrated in FIG. 7 wherein traffic is able to flow across the network 70. The traffic that is to flow inter-network passes through the Operator's network equipment center 71 and onto other networks such as the Internet 72 or other telecommunications networks 73, including the public service telephone network (PSTN) and cellular networks. FIG. 7 also shows an arrangement wherein the network can provide for fibre backhaul capabilities 75 for transmission of information directly to the Operator's network equipment centre 71 from an aggregation point e.g. 77.

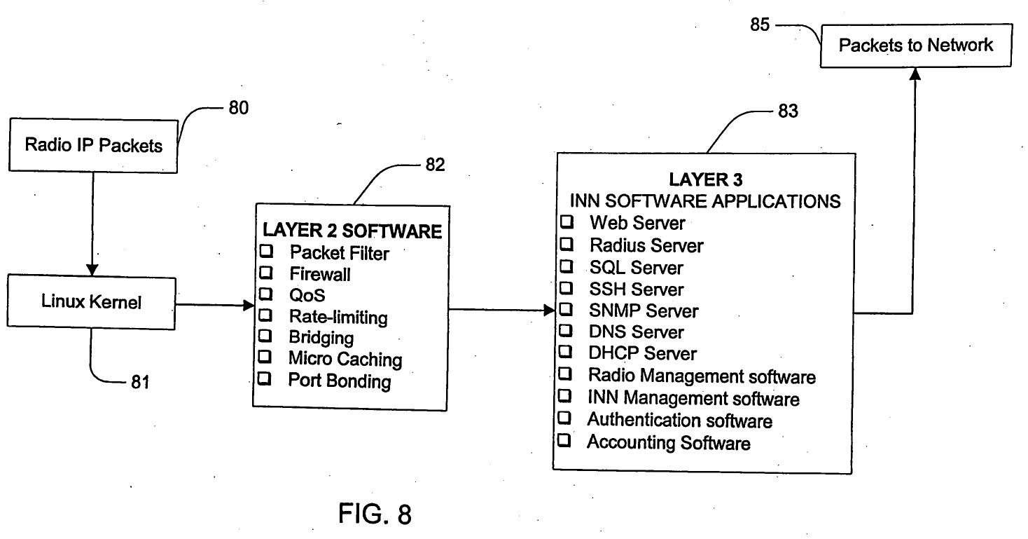

A simplified view of the software architecture of an INN, once it is booted up and its packages are downloaded and installed, is shown in FIG. 8. The base 802.11 protocols involve the transfer of radio IP packets 80. These are received and processed by the Linux kernel within the INN device. The layer 2 processing level 82 implements a number of packet processing techniques including packet filtering, firewall, quality of service (QoS), rate limiting, bridging, micro caching and port bonding. The packets are then utilised by layer 3 software applications 83 which can include a web server, RADIUS server, database SQL server, SSH server, SNMP server, DNS Server, DHCP server, radio management software, INN management software, authentication software and accounting software. The applications 83 send packets for output to the network 85.

Individual INNs manage the traffic flowing to and from the radios under its control. Each INN is part of the larger computing system that supports the 802.11 multipoint-to-multipoint metropolitan wide network. Traffic from end user devices flow to the radios, but by design the path the traffic flows to another location (such as a PAP) is not as predictable as the INNs operate in a multi-path environment. Preferably, at least three usable radio signals are presented from multiple INNs to roaming end user devices at any given coverage location. In this environment end user devices may roam between these INNs at any time. This will occur even if a user is stationary and more frequently if the user is mobile, including situations where the user is walking, running or in a vehicle. The network is designed to allow for this and in a time-sensitive manner (fast handovers), through inter-INN communication rules, rapid routing updates via Inter-Access Point protocol (IAPP) exchanges and via pre-authorization and pre-authentication methods.

Preauthorization and pre-authentication are functions of the INNs authorization, authentication and accounting (AAA) architecture and enabled via the IAPP daemon. To be able to access the network, the end user's device 42 must be authorized and their identity must be authenticated. The first time a user device 42 attempts to associate with a network radio, or after a previous user session has expired, a user device association request process is started. First the local distributed database of the INN is interrogated for a pre-authorization record. If this exists, and is valid, the device is immediately authorized for association with any radio managed by the INN. This is an extremely efficient process as data or processing does not leave the INN and provides for fast handovers and re-associations. It also conserves backhaul capacity. If the device is unknown a device association request is relayed to an INS server for centralized processing. This can be carried via a standard Radius request or via the IAPP daemon. The INS server will return the result to the INN once it has interrogated its centralized network database e.g. 58. If the device is rejected at the central INS server an unauthorized reply is sent back to the INN.

Unauthorized devices are not able to associate with a network radio and are hence “rolled-off” the network. This improves cohabitation between the network and other 802.11-based networks within the same geographical area, such as other service provider's hotspots, as unauthorized association requests are quickly rejected allowing the end user's device to associate with their intended 802.11 radio. Up to this point, little end user device data is allowed to pass beyond the INN—unauthorized user data is denied access by the firewall at each INN. On the other hand authorized devices are allowed to associate with the INN's radio.

The INS server returns authorization data including an authorization-accept message, details of the end user's device authentication capabilities, current end user's session status details and authentication preferences to the INN. The INS server also records details of the request, including the time and location. With the returned authorization data the INN interrogates its local distributed database for a pre-authentication record. If this exists and is valid, and the end user's session is also valid, the INN resumes the end user's session immediately, allowing for a fast handover. If there is no current pre-authentication record, or the end user's session is invalid, an authentication process is started.

Multiple industry-standard authentication methods can be supported on the network. Depending on the end user's authentication preferences and end user device capabilities the authentication process and data requirements may differ. Preferred authentication schemes are designed to allow for maximum compatibility with end user devices and support fast handovers. An example of a current authentication process is where an end user is required to login via a secure (SSL) web page to be authenticated. In this case, all end user web traffic from the end user is intercepted by the INN and redirected to a login page on the INN's distributed web server. Once the end user submits their login and password the request is relayed to the centralized INS server via a Radius or similar authentication protocol. The INS server will process the request, which may involve proxying the request to an external authentication server or aggregator, and return the result. Another current authentication example is where the INN will request an 802.1x negotiation with the end user device. As above, the authentication request is relayed to an INS server for processing. With all positive INS authentication replies, authentication data is returned to the INN including but not limited to a unique session identifier, session timeout value, user service plan and other QoS values such as the rate-limit option. This data can differ as authentication schemes change.

Once a user is authenticated on the network the INS, or controller INN will preauthorize and pre-authenticate via IAPP messages a predetermined number of other INNs from its network map database using its rules for inter-INN communication. The pre-authentication information can be similar to that returned by the INS server. These INNs cache this data for the period of the end user's session. The end user is then able to roam to radios on these pre-authenticated INNs without a slow re-authentication interruption.

The pre-authentication process provides an additional benefit by solving the wireless roaming end user accounting problem. In a network where end users roam from radio to radio and INN to INN, it is not feasible to count usage at a single network point as communications can often be peer-to-peer. Within the network, each individual radio counts usage data per end user and not all traffic flows through a single point, so matching usage records for a particular end user session is complex. However, with pre-authentication, all valid end user data is passed from each radio to its INN where it is collected and modified to support the pre-authentication session identifier. This accounting data is passed from each INN to an INS periodically to conserve backhaul capacity. The use of a single unique identifier for each end user session means billing details can be accurately aggregated and consolidated at the INS.

Other information that can be consolidated at the PAP is end user roaming location data. Because at least three usable wireless signals are presented to the end user at any time, and as that data is propagated from INNs to an INS server, near real-time location tracking of users can be performed using trigonometry rules. This information can be used for network planning purposes or for emergency services assistance.

Most 802.11 networks require terrestrial backhaul links from each POP site on their network. The preferred embodiment uses wireless backhaul links as shown in FIG. 1. Software code on the INN enables the INN to control the radios connected to it so that they can be used in dual-purpose roles; for both network coverage and wireless backhaul, avoiding the need for terrestrial links. Backhaul links can be configured to provide agnostic encryption and/or compression to provide data security and link efficiency benefits. In one embodiment, compression and encryption is provided in this manner only on network infrastructure wireless links, and not on wireless links from the INN to the end user. The INN can also dictate whether a radio linked to an INN operates as a user-access radio or backhaul radio. A backhaul path can be set to be a single radio, stacked radio or bonded in a pair of radios. The use of these bonded radios to increase wireless backhaul capacity also reduces packet-retries and congestion related errors on busy wireless links.

Another INN feature to improve link efficiency is by the use of micro-caching of local data. Radio and INN buffers are used to cache data thus reducing data retries across backhaul links. Web-based software caches can also be used to also increase efficiency and reduce roundtrip retries.

To be a viable commercial network, the system must be easily manageable. The system can be maintained via a comprehensive centralized web based management system that can be accessed from inside the network or externally via secure encrypted access such as a VPN connection. The web-based system is modularized and permission-based-providing the user access to certain modules of the system based on the end user's permissions. Modules include management of network: INNs, INS, radios, end user's, operators, monitoring and code packages. The web system can provide a view of the entire network operation including near real-time data and graphs of network usage. This data can be returned to the INS from INNs via the standard SNMP protocol. All changes to the network via the web system are stored in the INS master database as opposed to other network systems where individual device configuration is stored within the device itself, such as an off-the-shelf wireless radio. Configurations in this environment can be difficult to maintain and lead to scalability problems as it becomes difficult to manage the plethora of devices and their versions within the network.

Network faults or equipment overloads can have an impact on end user access and affect service level agreements (SLA). The wireless networking system is designed to firstly be redundant against individual component faults on the network, and secondly to detect such situations and take action to address these problems. Examples include:
Service redundancy due to at least three usable radio signals from different INNs being presented to any end user at any one time. Therefore if a radio, INN or POP fails in the network, the end user simply and automatically associates with the other available radios and their session is not interrupted.
Dynamically reconfiguring radio roles to provide dynamic aggregation points thus providing greater backhaul capacity when capacity within a coverage area is constrained;
Preventing radios accepting more end users when capacity is reached.
Dynamic INN link and route changes to workaround temporary link failures or lowering of link performance.

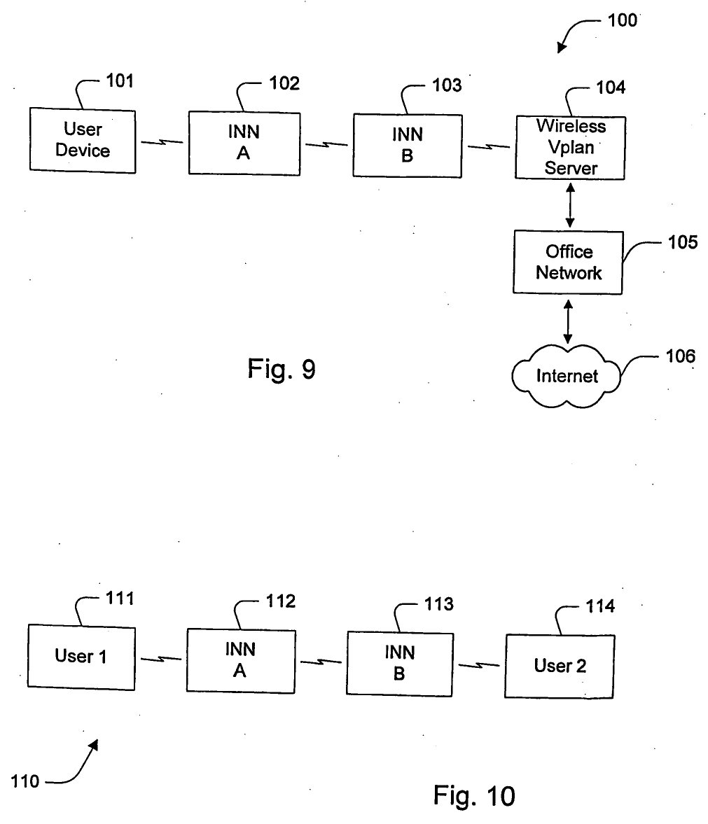

Further, networks of the preferred embodiment allow for other possible traffic types. For example, where an office includes its own internal network, the arrangement 100 as illustrated in FIG. 9 could be implemented wherein wireless devices 101 interconnect across the network with a series of INN type devices 102, 103 and from there with a server 104 which implements a VPN connection between the device 101 and an office network 105 which in turn can be connected to the Internet 106. Of course, cross network traffic is also possible. An example of this type of traffic is illustrated in FIG. 10 wherein two users 111 and 114 are interconnected across the network via intermediate INN devices 112, 113.

Additional network management software is enabled on each INN to allow network operators access to commonly performed diagnostic or performance testing tools. From the INN command-line management tool operators can perform tasks such as reboot an INN, restart a radio, test and recreate a network link, test authentication processes, update a software package etc. Diagnostics can also be run such as tests of link performance, INN load, memory available and so on.

The foregoing describes preferred embodiments of the present invention, modification, obvious to those skilled in the art can be made thereto without departing from the scope of the invention.

1. An infrastructure-based metropolitan-wide multipoint to multipoint wireless networking system comprising:
at least one primary aggregation point (PAP), housing intelligent network servers (INS) that provide centralised services,
a series of geographically dispersed intelligent network nodes (INNs) providing point of presence (POP) operations throughout the networking system;
said INS and said INNs being interconnected by a series of radio transmission devices so as to provide for metropolitan wide networking.

2. A system as claimed in claim 1 wherein said INS is further interconnected to external networks so as to provide external network communication for said system.

3. A system as claimed in claim 2 wherein said INS manages network control access and communications between a network INN and external networks such as Operator networks and the Internet.

4. A system as claimed in claim 1 wherein said INN devices are in radio communication with each other, the INS and roaming end user devices.

5. A system as claimed in claim 4 wherein said INN devices provide wireless backhaul operations for transmission of information from said roaming end user devices via intermediate INN devices by means of a multipoint to multipoint wireless transmissions to a PAP or SAP for on transmission to other communications networks.

6. A system as claimed in claim 1 wherein said system presents at least three useable wireless signals for wireless connection to roaming end user devices throughout the metropolitan network area.

7. A system as claimed in claim 1 wherein at least one of said INNs is utilised as a network aggregation point (SAPs), wherein wireless data is forwarded to the SAP and then transmitted by a higher capacity link to the INS.

8. A system as claimed in claim 1 wherein said INN devices include power and environmental controls to enable efficient year round operation of the POP site

9. A system as claimed in claim 1 wherein end users are able to roam seamlessly throughout the metropolitan-wide network, within predetermined network boundaries whilst remaining connected to remote network services and resources, allowing the uninterrupted performance of computer applications as the end user moves through the network, transiting from one radio connection to the next in a transparent manner.

10. A system as claimed in claim 1 wherein said network is IEEE 802.11 compliant.

11. A system as claimed in claim 1 wherein unauthorised users are disassociated at the INN to which they first interconnect with.

12. A system as claimed in claim 1 wherein the radio transmitters of various pairs of INN devices form a preferential link for the transmission of information.

13. A system as claimed in claim 1 wherein the INN support micro-caching of transmitted packets thereby increasing efficiencies over wireless backhaul links.

14. A system as claimed in claim 1 wherein authorised end users can access uninterrupted network services whilst being stable or in motion in a predetermined network area.

15. A system as claimed in claim 1 where end users can roam into the network and perform association and authentication tasks online.

16. A system as claimed in claim 1 wherein new users to the network can provision themselves for first time use of the network.

17. A system as claimed in claim 16 wherein the new user is provided with a web browser splash page that allows the new user to complete relevant sign-up details without gaining full access to the network.

18. A system as claimed in claim 17 wherein the network automatically validates the login details online, and provides the end user with a network authentication result.

19. A system as claimed in claim 1 where said intelligent network servers utilise stored access authority information for determining whether said roaming end user communications device can access said network and wherein upon a roaming end user communications device initially attempting a wireless association to the network via a first INN, said INN interrogates said INS to determine if said roaming end user communications device is authorised to access the network and upon receiving a positive authentication result, said INN caches said positive result at one or more predetermined INNs in the network

20. A system as claimed in claim 1 where the positive authentication result is forwarded to a predetermined number of INNs (pre-authentication).

21. A system as claimed in claim 1 wherein said system is configured so that at least three signals are presented to the roaming end user at any time, throughout the network.

22. A system as claimed in claim 21 where said system is adapted to utilise the reception pattern of receivers so as to triangulate the position of an end user.

23. A system as claimed in claim 21 wherein the user location information is used for one of real time tracking, network planning purposes or direction of emergency services.

24. A system as claimed in claim 1 wherein communications between said INS and said INN occur via wireless transmissions.

25. A system as claimed in claim 1 wherein the best radio path is pre-selected for routing traffic to or from the INS and INNs.

26. A system as claimed in claim 1 wherein a maximum of five transmission hops is provided between each INN and the INS.

27. A system as claimed in claim 1 wherein said INN and INS include computer processing elements, and wherein network administration programs and distributed network applications are downloaded from the INS to each INN on boot-up of the INN as part of automatic code management practises enabled on the system.

28. A system as claimed in claim 1 wherein said INN interrogate an INS server on boot-up for its individual configuration settings file and upon receiving said file reconfigures itself based on the configuration values within the file.

29. A system as claimed in claim 1 wherein said INN boots-up as an end user-device in order to download its individual configuration file as per claim 28.

30. A system as claimed in claim 1 where each INN performs a predetermined role in the network functions provided by the overall system, including backhaul and routing functions, as determined by the logical connectivity of individual POPs within a predetermined network topography.

31. A system as claimed in claim 1 wherein INNs may utilise at least one of compression and encryption of information transmissions over backhaul radio links.

32. A system as claimed in claim 1 wherein the INS provides centrally managed network services and network applications in support of INNs and roaming end user devices.

33. A system as claimed in claim 1 wherein said authority information includes a session identifier and said INNs store traffic information associated with said session identifier and periodically forward said traffic information to said INS for network management and recording.

34. A system as claimed in claim 1 where said system provides standards-based interconnect points at the INS and at aggregation points to allow for efficient transport of information to Operator networks

35. A system as claimed in claim 1 where the INNs provide distributed managed network services and network applications in support of roaming end user devices.

36. A system as claimed in claim 1 where metro-wide wireless VPN access is supported via VPN pass-through capability in the INNs and INS.

37. A system as claimed in claim 1 wherein a first and second wireless system are interconnected by a Virtual Private Network which transmits over a third parties infrastructure.

38. A system as claimed in claim 1 wherein each INN continually monitors the state or condition of each of its radio links, producing a quality measure in relation thereto and alters a current link when the quality measure falls below a predetermined quality measure for a predetermined length of time.

39. A system as claimed in claim 1 wherein each INN includes a computer device interconnected to a plurality of radio transmitter devices.

40. A system as claimed in claim 1 wherein each INN includes a computer process for monitoring and controlling each radio and or network connection under its control.
